(19) United States
(12) Patent Application Publication
(10) Pub. No.: US 2007/0014826 A1
(43) Pub. Date: Jan. 18, 2007

(54) Roach bait attractive to many species of roach and useful in their rapid control

(76) Inventor: James Hua-Hin Chan, Martinez, CA (US)

Correspondence Address: HARRY A. PACINI, 410 HIDDEN MEADOWS CT., RENO, NV, 89502-8764, US

(21) Appl. No.: 11/178,536

(22) Filed: Jul. 12, 2005

(51) Int. Cl. A01N 25/08

(52) U.S. Cl. 424/410

(57) ABSTRACT

An attractant bait composition has been discovered for the control of many species of roaches. A similar group of baits were also found to be effective for the control of wasps, flies, termites, and mosquitoes. The composition includes a food base, attractants, sweeteners, carriers, dispersants, surfactants, fragrances, preservatives and a toxicant or toxicants. Important further considerations in the design of a bait material is the consistency of the bait, taste of the bait, speed of action of the toxicant, type of toxicant and odor as perceived by the various insects.

### BACKGROUND OF THE INVENTION

Roaches have been a problem to man for thousands of years. Various means have been used over the years to control them. Many of these are described in the US patent literature and art. These have been effective to a greater or lesser degree, but all the different ways have problems in degree of control or length of time in their effectiveness. Insecticidal sprays are generally of less utility when compared with an effective bait. Insecticidal sprays require much more toxicant than is usually needed for a properly designed bait. Sprays too only give partial control of the roaches in their nest and they quickly recover. Baits for many roach species is the best tactic in that the nests are completely destroyed. This gives a more permanent solution to the particular roach problem. A properly designed bait will use low levels of toxicant and thus have low levels of toxicity to those living in the area and to their pets or animals or birds. When residual sprays are used in the area, roaches may die before they take treated baits back to the nest or warn the remainder of the nest of the potential toxicity of the bait. Thus sprays should not also be used when baits are set for control. Also this points out the importance of having the proper level of toxicant in the bait so that premature death of the carrier roach does not occur. Baits must not show toxic effects until sometime after the carrier roach returns to the roach colony. But the total toxic effect should occur within a few hours after the carrier roach arrives at the nest. Slow acting toxins often allow the remaining part of the colony to move from the area and form new colonies.

Another important aspect of bait design is to have a bait that is readily located by the roach and then taken quickly back to the offending nest to the queen roach and the rest of the colony. Here it is important that the bait is attractive to the offending roaches in the foraging area. They must readily accept it in preference to other food available in the area. It is usually important that the bait not be placed on the offending roach colony because this puts the roaches on the alert to the potential of tainted food. Still at the same time the bait must be placed in the area where the roaches are actively foraging for food. It is also important that the size and texture of the bait is such that it is readily accepted and taken back to the nest with only minor consumption by the foraging roach. A human analogy is that it must act like desert and taken home for the rest of the family to enjoy. This further points out the importance of texture, attractiveness, taste and smell in the design of an effective roach bait. Here the bait must have the proper smell appeal to the roach and at the same time not have an objectionable odor to people living in the area. Here the proper use of various fragrances is important and will be discussed later. Fragrances can be both attractive and repulsive to roaches. Therefore odor characteristics of the bait are very important.

Baits for sugar loving roaches require that sweeteners or taste enhancers be included in the design of roach baits. The proper choice of a sweetener is very important in the design of an roach bait. Sweetness or taste to roaches is not the same as that perceived by people or other animals. For outdoor treatment the bait should not also be attractive to animals and birds in the area. Color is also important in this regard. Certain bright contrasting colors are often attractive to birds and animals.

Each of the above important characteristics elicited above will be further described relating to the current invention.

### DESCRIPTION OF THE PRIOR ART

There is a considerable amount of prior art that has developed over many years in the field of insect bait design and roach bait in particular. However, many of these approaches are overly simplistic in their teaching and design. There are many characteristics necessary for an effective roach bait as described above and will be further described in the body and claims of this invention. Certain characteristics are obvious in the design of an effective roach bait. The prior art teaches that there must be an attractant, a carrier, and a toxicant. This art is exemplified in the currently available commercial roach baits available today. These are targeted to only certain types of roach pest or species—such as sweet loving or oil loving roaches. There are approximately 3,500 species of roaches with their own special characteristics. The following is a listing of common roaches found in and around domestic dwellings:

| | |
|---|---|
| German Cockroach | Blattella germanica |
| Brown-Banded Cockroach | Supella longipalpa |
| Oriental Cockroach | Blatta orientalis |
| American Cockroach | Periplaneta Americana |
| Wood Cockroach | Parcoblatta spp. |

The following is typical of the various types of roach baits found for use on roaches:

Baits:

| Product | Active Ingredients |
|---|---|
| Baygon 2% Bait Insecticide | Propoxur (2%) |
| Gold Crest Propoxur 2% Bait Insecticide | Propoxur (2%) |
| Gold Crest Roach & Ant Bait Insecticide | Chlorpyrifos (0.5%) |
| Impact Roach Bait | Chlorpyrifos (0.5%) |
| Maxforce Bait Gel | Hydramethylnon (2.15%) |
| Maxforce Insecticide Roach Control System | Hydramethylnon (1.65%) |
| Prentox Larva-Lur With Dylox | Trichlorfon (5%) |
| Stapletons Mag. Roach Food M.R.F. 2000 | Boric acid (33.3%) |
| Paste | |

The presence of cockroaches in the home is a major cause of distress to home and apartment dwellers than nearly any other insect pest. Part of the distress is due to the fact that most people dislike any insect in the home. In addition, there is a common perception that cockroaches live in homes that are dirty and not well kept, so there is also a negative stigma attached to seeing them around the home. However, cockroaches live in dwellings belonging to all ethnic groups and all economic classes of people. Bad housekeeping does not automatically mean a person will have an infestation; likewise, immaculate housekeeping does not exempt the resident from having cockroaches. Because they are often brought into non-infested residences through human activities, the cleanliness of the new place is immaterial.

However, a clean home will not sustain as many cockroaches as an identical home that is cluttered and dirty because there is less food for the cockroaches to eat. Many other factors, like humidity, temperature and cracks and crevices are very important in influencing infestation levels.

German, brown-banded, oriental (i.e., waterbugs), and American cockroaches, are world travelers, living with humans nearly everywhere across the globe. These pests have been implicated in cases of Salmonella food poisoning They have also been found to harbor Staphylococcus, Streptococcus, E. coli and other bacterial pathogens.

The main reason that cockroaches should be eliminated or killed is that they harbor and transmit disease pathogens. During daylight roaches hide and feed on sewage in city sewers, or hide and feed on garbage in garbage or trash receptacles. During the night they come out of the sewers and garbage receptacles, invade homes searching for food. When food is located, roaches regurgitate the ingested sewage or garbage from their stomachs onto the clean human food before they begin feeding. When the unsuspected contaminated food is next eaten by humans, very serious diseases can result from the disease bacteria in the cockroach digestive system. Also, human food or utensils can become contaminated with cockroach feces after the roaches have finished feeding. It has been shown that Salmonella bacteria survive in cockroach feces for several years.

Many people who are allergic to house dust are also allergic to cockroaches. In infested homes, crushed cockroach body fragments and feces become a major constituent of house dust. Some people develop allergies to this dust after long-term exposure either from cockroach-infested dwellings or from working in scientific laboratories where they are reared for experiments. In addition, asthma can be induced by a person's allergy to this cockroach dust. It has been shown that the incidence of asthma and allergies is greater in people continually exposed to cockroach infestations.

The typical commercial bait for roach control is composed of a carrier plus an attractant or food such as vegetable oil or soybean oil or a sugar as the attractant in the bait plus a toxicant of some kind. Improper choice of vegetable oil or sugar is actually repulsive to some roaches to baits. Also oils become rancid on storage and repellent to many roaches. Similarly many toxicants are repulsive to roaches. With the exception of the present invention roach baits do a poor job in controlling a wide variety of roaches. In general they lack shelf or field stability and most preservatives are actually repellant at the usual use concentrations.

U.S. Pat. No. 5,939,061 to Vail, et. al. represent the current art for a method of attracting a variety of pest arthropod species including roaches. The method suffers from the fact that it is not a method of killing roaches and their colonies. Roaches are attracted to the bait but also need to carry the bait to the remainder of the colony where it can kill the total colony and thus control that particular roach problem.

### DESCRIPTION OF THE INVENTION

An roach bait consists of an active toxicant or insect control chemical mixed with an attractant or food. The roach bait can be a liquid, solid or gel. In case of a solid roach bait, the active toxicant and attractant is coated onto a carrier particle for the roach to carry the bait back to the nest.

In order for an roach bait of the current invention to provide effective control of roaches, the following ingredients are necessary:

Active Toxicant

The active toxicant should show little or no repulsion to roaches. It can be a solid (also a water soluble solid) or a liquid.

Speed of kill of the active toxicant should be moderate, requiring approximately 8-10 hours. This moderate speed of kill of approximately 8-10 hours allows the roaches sufficient time to bring the roach bait back to feed the rest of the roach colony.

A moderate speed of kill allows time (or distance) for the roaches to carry the bait back to the roach colony, allowing the roach to feed the rest of the roach colony, resulting in the kill of the entire colony.

A fast speed of kill (<0.5 hour) causes the roaches to die before they have sufficient time to reach the roach colony, thus allowing the rest of the roaches in the colony to survive

Instead of a killing toxicant (0.5-10 hours for kill), an Insect Growth Regulator (IGR) is some times used in the roach bait, requiring 2-3 months before a decrease in the roach colony is observed. This slow action of an IGR is due to deformation of the eggs and the newly hatched roaches in the roach colony, not the current roaches that living in the colony. This slow action of the IGR baits allows the existing colony of roaches to infest the surroundings areas for at least two months before there is a decrease in activity.

Active toxicant (such as phosphate insecticides) decomposes (hydrolyzes) at a relatively fast rate resulting in the following:

Roaches are slow to build up resistance to a phosphate toxicant. Roaches and other insects are able to build up resistance when exposed over long periods of time to an active toxicant that is relatively stable.

The active phosphate toxicant, in dead roaches or from the roach bait, decomposes or hydrolyzes in the environment to form phosphates that become nutrients for plants and trees.

The use of active toxicants containing chlorine, as well as toxicants that have high mammalian toxicity, in baits should be avoided. These active chlorinated insecticides used in roach baits, decompose or hydrolyze in the environment to form hydrogen chloride, or other chlorides that may be environmentally damaging. High mammalian toxic insecticides should not be used near human habitation, plantations and waterways. The use of large quantities of roach bait containing these chlorinated or toxic insecticides should therefore be avoided.

An effective roach bait can control roach infestations with the active toxicant level used at concentration levels of grams/acre. In the case of spray treatments, the active insecticide level used is at least ten to hundreds of times higher in concentration levels. Spray treatments require very high active insecticide levels that are not only wasteful and expensive, but are also hazardous and toxic to the environment.

The following are organophosphates which can be used as toxicants in roach baits at the proper low use level: acephate, azinphos-methyl, chlorpyrifos, diazinone, malathione, phosmet, prothiophos, pyrimiphos-methyl, and many others. Also the synthetic pyrethroids may be used as toxicants in roach baits at the proper use level: cyfluthrin, deltamethrin, permethrin, and esphenvalerate. Other toxicants would include: methomyl, carbaryl, and imidacloprid, and the like. Acephate is the most preferred toxicant.

Surfactant

Impregnation of the active insecticide in a water and or water soluble solid surfactant effectively extends the time of insect kill by slower release of the active insecticide in the roach after the roach has ingested the bait. This allows greater time for the roach to bring the bait back to the nest, feed the roaches in the colony, resulting in the kill of the entire colony.

The solid surfactant will mask the strong odor or repulsiveness of the active insecticide and allow maximum acceptance of the roach bait.

In case solid surfactants are unavailable, impregnation of the odorous active insecticide with small amounts of solids or oils of greasy animal and/or vegetable oils (including margarine, butter, peanut butter, cheese, bacon fat) are effective methods to impregnate the active insecticide.

Attractant

Different species of roaches prefer different types of foods. They can be classified as follows:

Sweetener (sucrose and fructose), syrup, honey loving roaches.

Oil (peanut, corn, sesame, soybean, palm and other vegetable oils, and animal fats) loving roaches.

Protein (animal and vegetable protein as found in cat and dog foods) loving roaches.

Chitin (shrimp and other shell crustacean) loving roaches.

Milk (milk, evaporated, condensed milk, powdered milk products) loving roaches.

In general, a roach bait should be tested for acceptance for a particular species of roach with the various above attractants before it is produced on a large scale for any type of roach eradication program.

Comparison tests or studies with any combination of the above attractants should be compared against a standard roach bait to determine if attractant combinations provide added synergies.

A general or universal roach bait is formulated by using various amounts of the attractants listed above.

Carrier

In a solid roach bait, a carrier (such as ground up bread crumbs, corn cereal or other types of grain) is used for impregnating or coating the intimate active toxicant and attractant mixture. The carrier provides a means to grind up the roach bait to an optimum particle size so that the roach can easily bring the bait back to the rest of the roach colony.

For a liquid roach bait, an absorbent material such as a sponge, cotton ball, cotton swab, absorbent paper tissue, or any absorbent wick or material will be acceptable.

Gels or jelly roach baits, because they can be readily removed in any size by roaches chewing on it, are ideal for roaches to break up and bring back to the roach colony.

Antioxidants

Antioxidants are necessary to extend shelf life of the packaged roach bait. They also prevent rancidity due to oxidation of the attractant in the roach bait when it is applied in the home. Its presence in the roach bait is particularly important when used out doors in sewers, garbage, trash, garden, open field or any outside environment due to rain and moisture.

Most antioxidants such as butylated hydroxy anisole and butylated hydroxy toluene (BHA and BHT) are repulsive to roaches in higher concentration levels in the roach bait.

A small concentration level of BHA/BHT is formulated in a roach bait, showing little or no repulsion to roaches. It also extends the shelf life of the packaged roach bait for periods of 1.5-2 years or more under normal cool and dry conditions.

Physical Properties

Vapor pressure of the bait components is very important in the design of a attractive roach bait. The bait must be able to release its attractive vapor components at such a rate that it does not rapidly loose its attractiveness. At the same time there must be sufficient volatility for the roach to locate the bait. Also the baits must not quickly “dry out” and become hard and difficult for the roach to ingest. Here the proper use of softening and formulating aids is important in giving the right texture and feel to the bait. Many of the bait components readily decompose and require the addition of preservatives in order to maintain the effectiveness of the bait. It should be mentioned that many necessary components and preservatives are not attractive to roaches and even in some cases are repulsive to them.

### DETAILED DESCRIPTION OF THE INVENTION

The following details the conditions of the invention with examples of various uses giving examples of the procedures and results of tests.

Bait Characteristics:

The following are examples of the current invention and the various active roach baits and their composition and testing use.

Active Toxicant:

The following are organophosphates that can be used as toxicants in roach baits at the proper low use level: acephate, azinphos-methyl, chlorpyrifos, diazinone, malathione, phosmet, prothiophos, pyrimiphos-methyl, and many others. Also the synthetic pyrethroids may be used as toxicants in roach baits at the proper low use level: cyfluthrin, deltamethrin, permethrin, and esphenvalerate. Other toxicants would include: methomyl, carbaryl, and imidacloprid, and the like. Acephate is the most preferred toxicant.

Surfactant:

The most effective surfactantes are solid ethoxylated alcohol and alkoxylated alkyl diamino nonionic surfactantes such as the Pluronic and Tetronic surfactantes. Solid water or oil soluble surfactantes are equally effective for impregnating the active toxicant.

Attractant:

The most effective attractants are the following:

Sweeteners such as sugar (sucrose, fructose, etc), bee honey, fruit nectars, syrups and others.

Natural oils such as oils from animal (bacon fat etc), fish (cod liver and others), vegetable oils (soybean, peanut, sesame, corn, palm, safflower, olive, and others).

Protein (animal and vegetable protein, dried fish and shrimp protein and protein in commercial dog and cat foods).

Chitin (shrimp, crab, lobster and other crustacean shells) that are ground up to a small particulate size.

Milk (milk; evaporated, condensed and powdered milk products).

Combinations of all of the above types of attractants (sugar, oil, protein, chitin and milk) in an roach bait provides a general or universal roach bait that is attractive to practically all species of roaches.

Carrier:

The following are the most effective carriers for roach baits:

Solid support such as dry bread crumbs, cereal, corn meal, corn grits and others for solid roach baits.

Absorbent material such as sponge, cotton balls, cotton swabs, absorbent paper tissue and others for liquid roach baits.

Gels and jelly roach baits containing the attractant and active toxicant. Hydrophilic polyhydroxyl polymers and co-polymers such as xanthan gums of various types (such as Kelzan®) are examples of gel forming substances.

Antioxidants:

Butylated hydroxy anisole (BHA) and/or butylated hydroxy toluene, tertiary butylhydroquinone and others (see The Florida Entomologist, Vol 17, No. 3, 1974) are the most effective antioxidants in roach and other insect baits.

Fungicide and Bactericide:

1,2-benzisothiazolin-3-one (Proxel®, trace amount, 0.02-0.06%) provides a needed fungicide/bactericide for effective roach baits.

Fragrance:

Rose, strawberry, lemon or other fragrances (small amount 0.5-0.8%) provide the right odor for bait control of roaches.

Surfactant (Odor Masking):

Solid water or oil soluble ethoxylated alcohols (BASF Pluronic® and Tetronic®, 10-50%) act as surfactants and mask many objectionable odors.

Dye:

Calco Oil Red N-1700® (0.05-0.07%) is an example of the type of effective dye used

Physical Characteristics:

Solid roach bait screened or sieved to optimum particle size for particular roach species.

Anti-agglomeration materials (0.2-1.0) %; amorphous diatomaceous, silica or clays) is added to prevent agglomeration of the roach bait.

### EXAMPLES OF THE INVENTION

The following roach bait formulas list examples of liquid, solid and gels for various species of roaches or roach groups:

### Example 1

Liquid Roach Bait for Sugar Loving Roaches

| Ingredients, Wt. % | 1a | 1b | 1c | 1d |
|---|---|---|---|---|
| Acephate, 99.5% | 1.2 (0.8-1.6) | 1.2 (0.8-1.6) | 1.2 (0.8-1.6) | 1.2 (0.8-1.6) |
| Sugar (Granular Hawaiian) | 20.0 | 15 | 15 | 15 |
| Honey (Bee honey) | — | 5 | 5 | 5 |
| Proxel ® | — | 0.02 | 0.02 | 0.02 |
| Fragrance (Rose) | — | — | 0.5 | 0.5 |
| Dye (Calco Oil Red N-1700) | — | — | — | 0.05 |
| Water (Deionized) | 78.8 | 78.78 | 78.28 | 78.23 |
| TOTAL: | 100.0 | 100.0 | 100.0 | 100.0 |

1a - Technical Acephate, followed by sugar and honey are dissolved in water using a Blender or a mechanical/electric motor equipped with a stirrer blade.
1b - Same as 1a, except Proxel ® preservative is added
1c - Same as 1b, except Fragrance (Rose) is added
1d - Same as 1c, except Red Dye is added

The above formulations should be stored in a cool area or refrigerator, away from heat and light.

### Example 2

Granular Solid Roach Bait for Sugar Loving Roaches - House,
Garbage/Trash Receptacle Roaches

| Ingredients, Wt. % | 2a | 2b | 2c | 2d |
|---|---|---|---|---|
| Acephate, 99.5% | 1.2 (0.8-1.6) | 1.2 (0.8-1.6) | 1.2 (0.8-1.6) | 1.2 (0.8-1.6) |
| Peanut Butter (Skippy, Creamy) | 5.0 | 5.0 | 5.0 | 5.0 |
| Sugar (White or | 4.0 | 4.0 | 4.0 | 4.0 |
| Raw Hawaiian) | | | | |
| Honey (Bee | 1.0 | 1.0 | 1.0 | 1.0 |
| Honey) | | | | |
| Dry Bread Crumbs | 89.0 | 88.98 | 88.43 | 88.38 |
| Proxel ® | — | 0.02 | 0.02 | 0.02 |
| Fragrance (Rose) | — | — | 0.5 | 0.5 |
| Tenox 4 ® | — | — | 0.05 | 0.05 |
| Calco Oil Red N-1700 | — | — | — | 0.05 |
| TOTAL: | 100.0 | 100.0 | 100.0 | 100.0 |

2a - Technical Acephate, sugar, honey and Peanut Butter are ground up to form an intimate mix. Dry bread crumbs are added and thoroughly mixed to form a semi-dry, granular solid. This solid is ground up in a blender and sieved through a small stainless wire screen to give a fine solid.
2b - Proxel ® preservative is added to 2a when Acephate, sugar, honey and Peanut Butter are ground up and mixed.
2c - Fragrance and Tenox 4 ® are added to the Proxel ® in 2b.
2d - Calco Oil Red N-1700 added to the Fragrance, Tenox 4 ® and Proxel ® in 2c. If the solid roach baits (2a-2 d) tend to agglomerate, an amorphous Diatomaceous Earth (0.2-0.6%) is added to prevent agglomeration.

The acephate insecticide (in a water solution) can be sprayed onto the solid granular premix, tumbling in a small cement mixer or pan granulator. Some of the moisture from the acephate solution is allowed to evaporate during the tumbling process.

Store the above solid roach baits in a cool dry location, away from heat.

### Example 3

Gel Roach Baits for Sugar Loving Roaches - House, Garbage/Trash Receptacle
Roaches

| | 3a | 3b | 3c | 3d |
|---|---|---|---|---|
| | 10% Kelzan ® | 20% Kelzan ® | 30% Kelzan ® | 40% |
| Ingredients, Wt. % | Gel | Gel | Gel | Kelzan ® Gel |
| Kelzan ® Powder | 9 | 18 | 27 | 36 |
| Water, Deionized | 82.38 | 73.38 | 64.38 | 55.38 |
| Acephate, 99.5% | 1.0 | 1.0 | 1.0 | 1.0 |
| Sugar | 4.0 | 4.0 | 4.0 | 4.0 |
| Honey | 3.0 | 3.0 | 3.0 | 3.0 |
| Proxel ® | 0.02 | 0.02 | 0.02 | 0.02 |
| Fragrance | 0.5 | 0.5 | 0.5 | 0.5 |
| Tenox 4 ® | 0.05 | 0.05 | 0.05 | 0.05 |
| Dye | 0.05 | 0.05 | 0.05 | 0.05 |
| (Calco Oil Red N- | | | | |
| 1700) | | | | |
| TOTAL: | 100.0 | 100.0 | 100.0 | 100.0 |

The above gel roach baits are made in a low to a higher consistency gel. Anyone of the above gel roach baits can be formulated by first dissolving Acephate, sugar, honey, Proxel®, fragrance, Tenox 4® and dye in water. This mixture is next added to the Kelzan® powder and stirred until a gel of uniform consistency is formed.

The roach bait gel can be cut up or extruded into smaller pieces. These gel roach baits should be packaged in a sealed container and stored in a cool environment.

### Example 4

Granular Solid Roach Baits for Milk, Protein, Oil and Chitin
Loving Roaches

| Ingredients, Wt. % | Milk | Protein | Oil | Chitin |
|---|---|---|---|---|
| Acephate, 99.5% | 1.2 | 1.2 | 1.2 | 1.2 |
| Powdered Milk | 5.0 | — | — | — |
| Condensed Milk | 5.0 | — | — | — |
| Dog Food or Cat Food | — | 10.0 | — | — |
| Soybean Oil | — | — | 5.0 | — |
| Sesame Oil | — | — | 5.0 | — |
| Dried Shrimp Shells | — | — | — | 10.0 |
| Tenox 4 ® | 0.05 | 0.05 | 0.05 | 0.05 |
| Fragrance | 0.5 | 0.5 | 0.5 | 0.5 |
| Dye (Calco Oil Red N-1700) | 0.05 | 0.05 | 0.05 | 0.05 |
| Dry Bread Crumbs | 88.2 | 88.2 | 88.2 | 88.2 |
| TOTAL: | 100.0 | 100.0 | 100.0 | 100.0 |

The above roach baits are formulated by premixing all the respective ingredients for each roach bait and adding each premix to dry bread crumbs. The final mixture is again thoroughly mixed, ground up and sieved.

A solution of the acephate insecticide can be sprayed onto the solid granular premix, tumbling in a small cement mixer or pan granulator as described in Example 2 above.

### Example 5

### Granular Solid Roach Bait—Acephate Toxicant Impregnated in a Solid Water Soluble Surfactant

Granular Solid Roach Bait - Acephate Toxicant Impregnated in
A Solid Water Soluble Surfactant.

| Ingredients, Wt. % | % |
|---|---|
| Acephate, 99.5%/BASF Tetronic | 3.0 (1.5 active acephate) |
| Surfactant (50:50 Mixture) | |
| Sugar | 20 |
| Honey | 15 |
| Tenox 4 ® | 0.05 |
| Proxel ® | 0.02 |
| Dye (Calco Oil Red N-1700) | 0.05 |
| Dry Bread Crumbs | 61.88 |
| TOTAL: | 100.00 |

Acephate is impregnated in Tetronic surfactant (BASF, alky alcohol ethoxylate) by mixing and milling the mixture of both products in a Hammer Mill. Acephate and Tetronic surfactant can also be intimately mixed by dissolving equal quantities of both compounds in water and removing the water by rotary evaporation under vacuum (˜20 mm Hg) on a hot water bath. The above solid roach bait is formulated as described in the prior examples.

### Example 6

Solid Granular Roach Bait with Higher Acephate Insectide
Level for Exterminating Large Resistant Roach Colonies¹

| Ingredients, Wt % | 6a | 6b |
|---|---|---|
| Acephate, 99.5% | 1.2 | 3.0 |
| Sugar (Raw Hawaiian) | 5.0 | 5.0 |
| Honey | 10.0 | 10.0 |
| Powdered Milk | 10.0 | 100 |
| Condensed Milk | 5.0 | 5.0 |
| Dried Shrimp (ground up) | 10.0 | 10.0 |
| Dried Fish (ground up) | 10.0 | 10.0 |
| Dried Bread Crumbs | 48.73 | 46.93 |
| Proxel ® | 0.02 | 0.02 |
| Tenox 4 ® | 0.05 | 0.05 |
| TOTAL: | 100.0 | 100.0 |

Large resistant roach colony in sewer drains (S. E. Asia).

The solid roach bait is formulated, ground up and sieved as described in the prior examples. 6a gave high acceptance and roach kill (8-10 hours). 6B gave high acceptance and somewhat faster kill (4-6 hours).

### Example 7

Solid Granular, Creamy Solid Paste and Gel Roach Baits

| | 7a. | | |
|---|---|---|---|
| Ingredient, Wt. % | Granular Solid | 7b. Creamy Solid | 7c. Gel |
| Acephate, 99.5% | 1.2 (0.8-1.6) | 1.2 (0.8-1.6) | 1.2 (0.8-1.6) |
| Sugar (Raw Hawaiian) | 10.0 | 10.0 | 10.0 |
| Honey (Bee Honey) | 5.0 | 5.0 | 5.0 |
| Peanut Butter | — | 72.8 | — |
| Soybean Oil | 10.0 | 5.0 | 5.0 |
| Sesame Oil | 10.0 | 5.0 | 5.0 |
| Water, Deionized | 1.0 | 1.0 | 53.8 |
| Dry Bread Crumbs | 62.8 | — | — |
| Kelzan ® Powder | — | — | 20.0 |
| TOTAL: | 100.0 | 100.0 | 100.0 |

The solid and creamy solid roach baits are formulated as described in the prior examples. The gel roach bait is prepared by first mixing Kelzan® with the one half of the water required in the formula. The mixture of sugar, honey, soybean oil and sesame oil is mixed with the remaining half of the water and added to the prepared Kelzan® gel.

### Example 8

Liquid, Solid and Gel Fly and Wasp (Yellow Jacket) Baits

| Ingredients, Wt. % | 8a. Liquid | 8b. Solid | 8c. Gel |
|---|---|---|---|
| Acephate, 99.5% | 1.5 (1.0-2.0 | 1.5 (1.0-2.0) | 1.5 (1.0-2.0) |
| Sugar | 5.0 | 5.0 | 5.0 |
| Honey | 10.0 | 10.0 | 10.0 |
| Dry Shrimp or Fish | 5.0 | 10.0 | 5.0 |
| (Powdered) | | | |
| Dog/Cat Food | — | 73.38 | — |
| Tenox 4 | 0.05 | 0.05 | 0.05 |
| Proxel | 0.02 | 0.02 | 0.02 |
| Dye (Calco Oil Red N- | 0.05 | 0.05 | 0.05 |
| 1700) | | | |
| Kelzan | — | — | 10.0 |
| Water, Deionized | 78.38 | — | 68.38 |
| TOTAL | 100.0 | 100.0 | 100.0 |

The above liquid, solid and gel baits for flies are prepared as described in the prior examples.

### Example 9

Solid GranularTermite Baits

| Ingredients, Wt. % | 9a | 9b |
|---|---|---|
| Acephate, 99% | — | 1.2 (0.8-1.6) |
| Acephate/Tetronic (50:50) | 2.4 | — |
| Sugar | 10.0 | 10.0 |
| Honey | 5.0 | 5.0 |
| Pine Saw Dust | 80.6 | 81.8 |
| Water, Deionized | 2.0 | 2.0 |
| TOTAL | 100.0 | 100.0 |

The solid granular termite baits in Example 9 is mixed in a rotating pan granulator. The acephate insecticide, dissolved in water, is mixed with sugar and honey. The mixture is pored onto the finely ground pine (or other soft wood) saw dust in a rotating pan granulator.

### Example 10

Liquid and Gel Mosquito Baits

| Ingredients, Wt. % | 10a. Liquid | 10b. Gel |
|---|---|---|
| Acephate, 99.9% | 1.0 (0.8-1.2) | 1.0 (0.8-1.2) |
| Animal Blood | 98.93 | 88.93 |
| Tenox | 0.05 | 0.05 |
| Proxel | 0.02 | 0.02 |
| Kelzan | — | 10.0 |
| TOTAL | 100.0 | 100.0 |

The liquid mosquito bait is prepared by mixing the ingredients listed with fresh animal blood. The liquid mosquito bait is absorbed onto a wick, sponge or tissue. The gel mosquito bait is prepared as a gel as described in the prior examples. Both baits should be treated with a small amount of a non-coagulating additive to prevent coagulation. The mosquito baits should be refrigerated or placed in a cool dry location until ready for use.

### Roach Testing of the Various Baits Described in the Examples 1-7

The roach baits of the above examples were tested in their natural environment where the particular roaches were found. The baits were distributed in small amounts in the areas where the roaches were seen to be active. All of the baits were readily accepted by the various roaches. Gradually in all of the examples the numbers of roaches in the treated areas was reduced to the point that none could be found.

| Example | |
|---|---|
| Number | Percentage Roaches Killed |
| 1 a, b, c, d | 100% kill (Little or no live roaches observed after 8-10 hours) |
| 2 a, b, c, d | 100% kill (Little or no live roaches observed after 8-10 hours) |
| 3 b (a, c, d | 100% kill (Little or no live roaches observed after 8-10 hours) |
| not tested) | |
| 4 a, b, c, d | 100% kill (Little or no live roaches observed after 8-10 hours) |
| 5 | 100% kill (Little or no live roaches observed after 8-10 hours) |
| 6 a | 75-80% killed, with 20-25% live sewer roaches observed |
| | after 8-10 hours |
| 6 b | 100% kill (Little or no live sewer roaches observed after |
| | 4-6 hours) |
| 7 a, b, c | 100% kill (Little or no live roaches observed after |
| | 8-10 hours) |

Fly, Wasps (Yellow Jackets), Termites and Mosquito Testing of the Various Baits Described in Examples 8-10.

The fly, wasp, termite, and mosquito baits of examples 8-10 were tested in their natural environment where the particular insects were found. The baits were distributed in small amounts in the areas where the insects were seen to be active. All of the baits were readily accepted by the various insects. Gradually in all of the examples the numbers of insects in the treated areas was reduced to the point that none could be found.

| Example | |
|---|---|
| Number | Percentage of Insects Killed |
| 8 a, b, c | All flies were killed. Some flies died near bait. Others did not |
| | return. |
| 9 a, b | After bait was applied, the termite infested wood showed no |
| | activity. No dead termites were found. |
| 10 a, b | Not tested. No mosquitoes were located to run the bait test. |

The above descriptions and examples should not be taken as such to limit my claims. Although the invention has been described with reference to preferred embodiments and examples thereof, the scope of the present invention is not limited only to those described embodiments. As will be apparent to persons skilled in the art, modifications and adaptations to the above-described invention can be made without departing from the spirit and scope of the invention, which is defined and circumscribed by the appended claims.

1. A method of destroying roaches and their colonies by the use of a bait formulation comprising a roach attractant and a roach effective toxicant composition whereby said composition is carried back to the colony to effect control of the remainder of the colony.

2. A method of claim 1 wherein said bait is effective on multiple species of roaches.

3. A method of claim 1 wherein said bait is effective on sewer roach species.

4. A method of claim 1 wherein said bait toxicant is acephate used at a roach effective toxicant concentration effective on resistant roach species.

5. A method of claim 1 wherein said bait is contains a delayed effective amount of a toxicant such that roaches ingesting the bait are not immediately killed.

6. A method of claim 1 wherein said bait is composed of a toxicant at a non-lethal roach concentration to not kill roaches ingesting the bait until after they have returned to their individual colony.

7. The method of claim 6 wherein the toxicant in the bait is acephate at a non-lethal roach concentration to not kill roaches ingesting the bait until after they have returned to their individual colony.

8. The method of claim 1 wherein the said bait is composed of a toxicant plus an attractant composed of at least one of the following types: sweeteners, natural oils, proteins, chitin, or milk products.

9. The method of claim 8 wherein said bait is composed of a toxicant plus an attractant containing an effective amount preservative or antioxidant wherein said bait remains attractive to roaches.

10. The method of claim 8 wherein the said toxicant is acephate at a concentration such that the roaches ingesting the bait are not killed until after they return to their colony.

11. The method of claim 1 wherein the said bait is composed of a toxicant plus a carrier such as a dry support, absorbent material or gel type product attractive to roaches.

12. A granular bait for killing roaches in their nests comprising by weight, 1 to 3% toxicant, 10 to 30% of combination of attractants, 10 to 80% of a carrier, 5 to 10% of a combination of antioxidant, preservative, color, surfactant and fragrance such that the bait is taken back to the colony and is effective between 8 to 10 hours.

13. The granular bait of claim 12 wherein the toxicant is acephate.

14. The gel bait of claim 12 with the addition of a gel agent and water.

15. The gel bait of claim 14 wherein the toxicant is acephate.

16. The liquid bait of claim 12 comprising the addition of 60 to 80% water.

17. The liquid bait of claim 16 wherein the toxicant is acephate.

18. A roach bait composition having delayed toxic action to roaches comprising an roach attractant bait, a delayed toxic amount of a roach toxicant, a suitable carrier with adjutants, and a delayed action formulation free of roach repellency characteristics.

19. The roach bait composition of claim 18 wherein said toxicant and said formulation provides delayed toxicity allowing the roaches to return to the colony.

20. The roach bait composition of claim 18 wherein said toxicant comprises at least one insecticide selected from the group consisting of chlorpyrophos, acephate, avermectin, azinphos-methyl, diazinone, malathione, phosmet, prothiophos, pyrimiphos-methyl, synthetic pyrethroids cyfluthrin, deltamethrin, permethrin, esphenvalerate, methomyl, carbaryl, and imidacloprid,

21. The roach bait composition of claim 18 wherein said roach attractant bait is selected from the group consisting of sweeteners, natural oils, proteins, chitin and milk products.

22. A method of controlling roaches consisting essentially of application of an roach bait composition having delayed roach toxic action comprising an roach attractant bait, containing a delayed toxic roach effective amount of a roach effective toxicant, and in a delayed action formulation free of roach repellency characteristics.
